(19) United States
(12) Patent Application Publication
(10) Pub. No.: US 2003/0210728 A1
(43) Pub. Date: Nov. 13, 2003

(54) Method and device for influencing the dispersion in an optical resonator and optical resonator with influenceable dispersion

(76) Inventors: Rudiger Paschotta, Zurich (CH); Jurg Aus Der Au, Zurich (CH); Ursula Keller, Zurich (CH)

Correspondence Address: OPPEDAHL AND LARSON LLP, P O BOX 5068, DILLON, CO, 80435-5068, US

(21) Appl. No.: 10/369,355

(22) Filed: Feb. 18, 2003

Related U.S. Application Data
(63) Continuation of application No. 09/594,850, filed on Jun. 15, 2000, now abandoned.
(60) Provisional application No. 60/139,394, filed on Jun. 16, 1999.

(51) Int. Cl. H01S 3/08

(52) U.S. Cl. 372/92

(57) ABSTRACT

The invention bases on the idea to, in an optical resonator with a prism (1) as reflecting end element, equip the prism (1) with a focusing effect. The focusing effect can e.g. come about by means of a curved surface (12) or by means of an internal lens effect. By introducing the focusing effect the angular dispersion is considerably increased if the resonator parameters are chosen suitably; thus a high negative dispersion of the group velocity or a strong spatial mode or wavelength separation respectively on a short path length is made possible. In an embodiment the optical resonator is restricted by a first reflecting end element (1) and a second reflecting end element (3). The first reflecting end element (1) is designed as a focusing solid body with a first, plane optical surface (11) and a second optical surface (12), whereby the second optical surface (12) is reflective. The resonator further contains a further focusing element (4). The light (51, 52) hits the first surface (11) of the solid body (1) and is refracted into the solid body (1). On the second, curved surface (12) the light (51, 52) is focused and simultaneously reflected normally such that it spreads along its entry axis in opposite direction. This resonator is e.g. suitable for compensation of dispersion for ultrashort pulse lasers.

This is a continuation of U.S. application Ser. No. 09/594,850 filed Jun. 15, 2000, now abandoned, which claims priority from U.S. application Ser. No. 60/139,394 filed Jun. 16, 1999, each application hereby incorporated herein by reference.

The invention concerns a method for influencing the dispersion in an optical resonator, an optical resonator with influenceable dispersion as well as a laser containing this resonator according to generic terms of the independent claims.

Ultrashort light pulses, i.e. light pulses with a duration of pulse below ca. 1 ps, are employed for multiple application in physics, chemistry, biology, medicine, telecommunication etc. Ultrashort light pulses can e.g. be generated in mode coupled lasers. For generating ultrashort light pulses in a laser a precise monitoring of the dispersion of the group speed in the laser resonator is of decisive importance; this all the more the shorter the desired pulse duration is to be. Components in the laser resonator—e.g. the laser medium—contribute positive dispersion which would restrict the width of the pulse towards the bottom if it was not compensated. Therefore it is necessary to introduce negative dispersion in the resonator. With the negative dispersion the unwanted positive dispersion can be compensated or even overcompensated in an aimed manner (the latter e.g. for generation of solitons).

Dfferent methods or devices for influencing or compensating the dispersion in a laser resonator are known. Examples for such devices to be built into a laser resonator are:

A Gires-Tournois interferometer (F. Gires, P. Tournois, “Interferometre utilisable pour la compression d'impulsions lumineuses modulees en frequence, C. R. Acad. Sci. Paris, Vol. 258 (1964), 6112-6115)

A pair of diffraction gratings (E. B. Treacy, “Optical Pulse Compression with Diffraction Gratings, IEEE J. Quantum Electron., Vol. 5 (1969), 454-458)

A pair of prisms (R. L. fork et al., “Negative dispersion using pairs of prisms”, Optics Letters, Vol. 9 (1984), 150-152)

A Bragg reflector

A chirped mirror (P. Laporta, V. Magni, “Dispersive effects in the reflection of femtosecond optical pulses from broadband dielectric mirrors”, Applied Optics, Vol. 24 (1985), 2014-2020).

A device for dispersion compensation which develops the concept of the pair of prisms further is disclosed in the patent U.S. Pat. No. 5,553,093 (M. Ramaswamy, J. G. Fujimoto). The laser resonator described there is restricted by two reflecting end elements and, moreover, contains a focusing element. At least one of the reflecting end elements is designed as a prism with two plane surfaces forming an angle and has a reflecting coating. The elements in the laser resonator are arranged such that monochromatic modes with different wavelengths have different axes of spreading. This kind of laser resonator has advantages compared to the devices listed above. It does not require any additional elements on the inside of the resonator which are solely for the compensation of dispersion. Due to the reduction of the number of elements of the laser resonator the manufacturing cost is reduced and the adjustment is simplified. In spite of these advantages this laser resonator does not fulfill all criteria for making an ideal dispersion compensation possible. The negative dispersion and/or spatial separation only depends, apart from the material characteristics of the prism, on one characteristic of the rest of the resonator, on the distance L between the prism and the so-called X-point. We define the X-point as the point where the spreading axes of modes with different wavelengths cross. In order to now achieve a strongly negative dispersion it would be necessary to choose a very large distance L. This, in many cases, is not realizable, e.g. if the length of the resonator is to be kept as short as possible. The angular dispersion is also determined soley by the material dispersion of the prism.

The object of the invention is to show a method for influencing the dispersion in an optical resonator and to create an optical resonator with influenceable dispersion as well as a laser containing this resonator which do not have the above mentioned disadvantages. This object is achieved by the method, the resonator and the laser defined in the independent claims.

The invention bases, expressed in a simplified manner, on the idea of equipping the prism of a resonator known from U.S. Pat. No. 5,553,093 with a focusing effect. The focusing effect can e.g. come about by means of a curved surface or by an internal lens effect. Due to the introduction of the focusing effect the angular dispersion is, with a suitable choice of the resonator parameters, considerably amplified in comparison to the value which would be defined by the material characteristics in the resonator according to U.S. Pat. No. 5,553,093. The created negative dispersion of the resonator is also amplified by the same factor such that with the same value for distance L a considerably higher dispersion can be achieved. The invention thus allows more freedom and flexibility in its design or its layout respectively.

In the method according to the invention for influencing the dispersion of the group speed of light in an optical resonator the light enters a solid body through a first surface, is reflected of a second surface of the solid body and then leaves the solid body through the first surface. Here it is substantial that the light is focussed by the solid body. In a first variant the light is focused on at least one curved optical surface of the solid body. The curving can be spherical or non-spherical. This can e.g. happen in that by means of interaction of the light with the material of the solid body an inhomogeneous index of refraction is created in the solid body, it is however, also possible to use a material with a permanently installed gradient lens. The two variants can also be applied simultaneously.

The optical resonator according to the invention with influenceable dispersion contains two reflecting end elements which define a resonator activity as well as at least one solid body in the resonator cavity. The light in the resonator cavity can be focussed by means of the at least one solid body. The solid body advantageously comprises an at least partly reflecting optical surface and advantageously forms one of the reflecting end elements. For focusing the solid body, in a first embodiment, comprises an at least partly curved optical surface which is advantageously at least partly reflecting and curved in a convex manner. The curving can be spherical or non-spherical. In a second embodiment the material of the solid body is, for focusing, such that in the solid body an inhomogeneous refraction index can be generated or is on hand. This inhomogeneous refraction index can e.g. be generated by interaction of pump light with the material of the solid body or by means of a corresponding dopant profile in the solid body.

In the laser according to the invention with an optical resonator which contains an amplifying medium the optical resonator is designed according to the invention described above. The at least one solid body advantageously forms the amplifying medium.

By means of the invention the negative dispersion of the group velocity and/or the spatial modes or wavelength separations respectively are considerably amplified at a given value for distance L. Applications for the invention are e.g. the following:

a) The invention allows the manufacturing of high performance lasers for ultrashort light pulses in which merely the Brewster surface of the amplifying medium creates sufficient negative dispersion in its interaction with a focusing effect on the amplifying medium. Thus less prisms are required in the resonator which leads to less loss of light, less weight and less cost. As a sufficient group dispersion is achieved without a large value for distance L higher repetition rates are possible with pulse lasers through the invention. For Nd:glass lasers repetition rates in the region of 1 GHz should be possible, for Td:saphire lasers more should be possible. The high negative dispersion on a short optical path length is also advantageous for the method of “cavity dumping” with pulse lasers. Here, caused by the system, a high positive dispersion is introduced by elements such as Pockels cell, polarizors etc., the unwanted positive dispersion can be compensated in an efficient and simple manner through the invention and the negative dispersion can be matched by a shifting of the cavity mirror. Compared to e.g. a Gires-Tournois interferometer the inventive layout can compensate the dispersion in an extremely large region of wavelengths.

b) The invention also allows, at a very large bandwidth, influencing of the dispersion of a higher order or monitoring of it respectively e.g. by employment of solid body surfaces with non-spherical curving. Thus the dispersion of higher order in lasers for generating ultrashort pulses can e.g. be compensated.

c) The spatial separation of monochromatic resonator modes or of wavelengths respectively is increased by the invention. Thus it is possible to make the amplification by means of the amplification medium inhomogeneous, i.e. to introduce independent saturation for different wavelengths. The invention also makes an aimed forming of the amplification spectrum possible by means of corresponding design of the pump ray profile. Thus central wavelengths can e.g. be reduced by reducing the region of the pump ray in the region near to the axis. The spatial separation of wavelengths could also be exploited in a tunable continuous wave laser.

In what follows the invention and, for comparison, also the state of the art are explained in detail in connection with the following figures, whereby

FIG. 1 shows a diagrammatic layout of a resonator according to the state of the art,

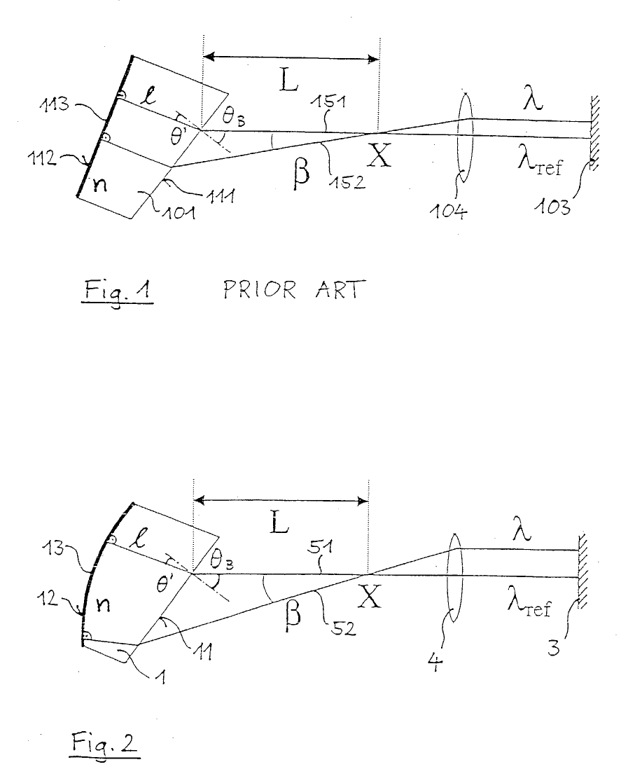

FIGS. 2 and 3 show diagrammatic layouts of two different embodiments of resonators according to the invention,

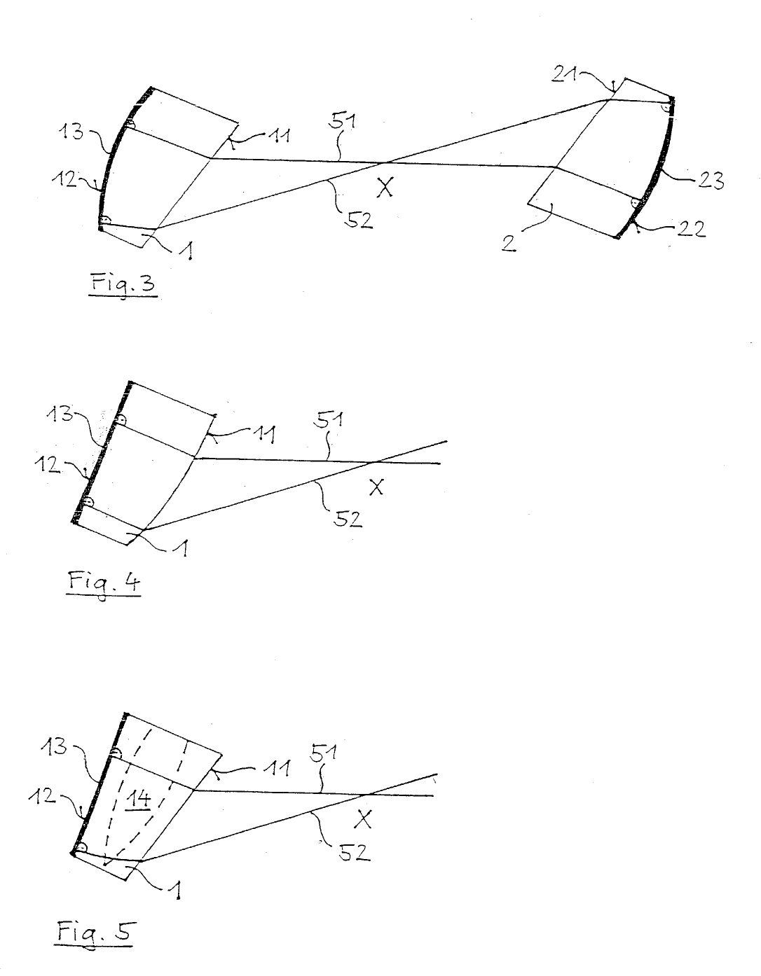

FIGS. 4 and 5 show diagrammatic views of solid bodies for two further embodiments of resonators according to the invention,

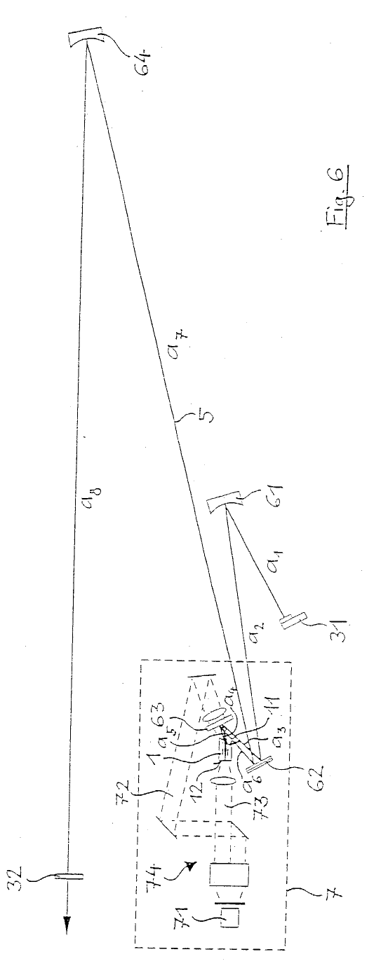

FIG. 6 shows a diagrammatic layout of an pulse laser according to the invention and

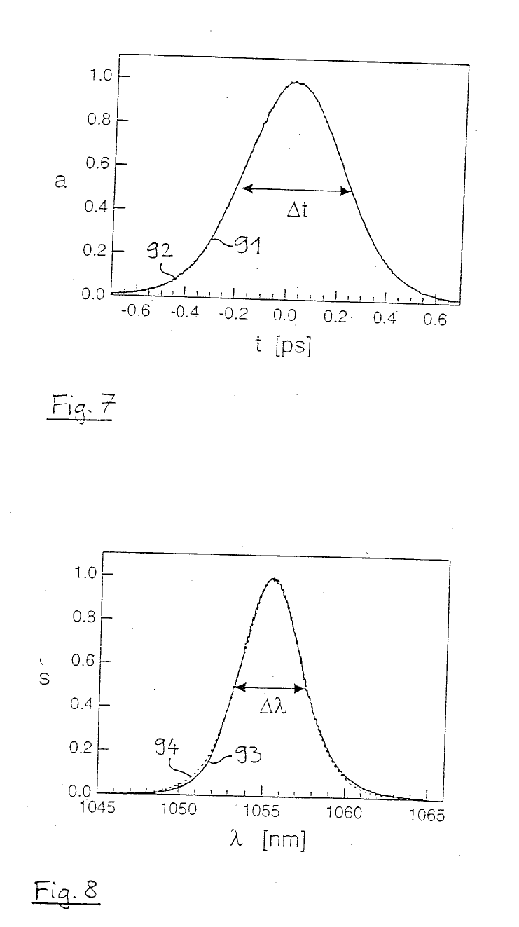

FIGS. 7 and 8 show readings of the auto-correlation function or the spectrum respectively with the pulse laser of FIG. 6.

FIG. 1 shows a resonator according to the state of the art diagrammatically, i.e. a resonator as disclosed in U.S. Pat. No. 5,553,093. The resonator is restricted by a first reflecting end element 101 and a second reflecting end element 103. The first reflecting end element 101 is designed as a prism of the refraction index n with a first plane surface 111 and a second plane surface 112 which carries a reflecting coating 113. Besides the resonator contains a focusing element 104. The elements 101, 103, 104 in the resonator are arranged such that the axes of spreading 151, 152 of modes of different wavelengths λ, λ_{ref} are separated spatially. The ray which passes the focusing element without being deflected is termed reference ray 151 and has a wavelength λ_{ref}. A further ray 152 with a wavelength λ<λ_{ref} is shown. The point where the two rays 151 and 152 intersect at an angle β is called X-point X. The X-point X is at a distance L from prism 101. The light, especially reference ray 151, hits the first surface 111 of prism 101 at Brewster's angle θ_{B}. It is refracted into the prism 101 according to the law of Snell at an angle θ′ and, after a distance l, reflected vertically of the second surface 112 of prism 101 and then it spreads along the respective entry axis in opposite direction. On the second reflecting end element 103 a normal reflection in itself also takes place.

In this resonator according to the state of the art the negative dispersion is proportional to the distance L and to the angular dispersion dβ/dω which is determined solely by the characteristics of the material. The negative dispersion of the group velocity is compensated by adjusting the position of the X-point X of the focusing element 104 by shifting. Thus, in order to compensate a predetermined dispersion the distance L must be calculated and the resonator optics must be chosen and arranged such that the demanded distance L is kept.

A first, preferred embodiment of the resonator according to the invention is shown diagrammatically in FIG. 2. The resonator according to the invention is also limited by a first reflecting end element 1 and a second reflecting end element 3. In opposition to the state of the art of FIG. 1 the first reflecting end element 1 is, however, designed as a solid body with a first, plane optical surface 11 and a second curved optical surface 12, e.g. a spherical surface 12 with a radius R. The curving of surface 12 can be incorporated when the solid body 1 is manufactured. It is, however, also possible for the curving to be formed by bulging due to local warming, i.e. due to interaction of light with the solid body. Also possible is a combination of a permanent and a thermally induced curving. The second optical surface 12 is reflecting, i.e. e.g. carries a reflecting coating 13.

The resonator further contains a further focusing element 4, e.g. a focusing lens. The elements 1, 3, 4 in the resonator according to the invention are arranged similarly as in the resonator of FIG. 1. The light, especially the reference ray 51 advantageously hits the first surface 11 of the solid body 1 at Brewster's angle θ_{B}. It is refracted into the solid body at an angle θ′ according to the law of Snell. On the second curved surface 12 of solid body 1 the light is focussed and simultaneously reflected normally such that it spreads along the respective entry axis in the opposite direction.

The advantages of the resonator according to the invention of FIG. 2 compared to the resonator according to the state of the art of FIG. 1 are obvious. For a given distance L a larger negative dispersion results with the resonator according to the invention than with the resonator according to the state of the art. This is due to the fact that the angular dispersion dβ/dω and thus the spatial separation of the monochromatic modes 51, 52 are larger. According to the invention, a desired negative dispersion and/or spatial separation of the monochromatic modes 51, 52 thus is not necessarily adjusted by changing of the distance L but by a suitable choice of the curving of the second surface 12 of solid body 1. This leads to additional freedom in the design of the resonator and saves spaces as well as expense.

The negative dispersion (group delay dispersion, GDD) of the group speed is determined for the arrangements of FIG. 1 and FIG. 2 by

$$GDD ∝ - \frac{ⅆ n}{ⅆ ω} \frac{ⅆ β}{ⅆ ω} L , \qquad ( 1 )$$

where ω=2πv is the angular frequency of the light. The material dispersion dn/dω is determined by the material characteristics. The angular dispersion dβ/dω is among other things dependent of the angle of incidence θ; for the resonator according to the state of the art of FIG. 1 it is

$$\frac{ⅆ β}{ⅆ ω} = \frac{tan θ}{n} \frac{ⅆ n}{ⅆ ω} , \qquad ( 2 )$$

whereas for the resonator according to the invention of FIG. 2 it is

$$\frac{ⅆ β}{ⅆ ω} = \frac{tan θ}{n} \frac{ⅆ n}{ⅆ ω} / [ 1 - {( \frac{cos θ}{cos {θ}^{′}} )}^{2} \frac{nL}{R - l} ] . \qquad ( 3 )$$

Thus, in the resonator according to the invention the angular dispersion dβ/dω and with it the negative dispersion of the group velocity GDD can be increased considerably compared to the state of the art by suitable choice of R and l. The denominator on the right side of Eq. (3) shows that, with the inventive resonator, there are critical values for R, L or l respectively at which a singularity of the angular dispersion dβ/dω occurs. This point, by the way, also represents a singularity for the transversal size of the resonator modes, which is actually disturbing. It showed, however, in the cases examined by us that when approximating the parameters to the singularity considerably (e.g. by a fact five to ten), increased values of negative dispersion are achievable before the size of the resonator modes changes considerably. Therefore the increase of the negative dispersion due to the invention can actually be exploited practically.

FIG. 3 shows a second embodiment of the resonator according to the invention diagrammatically. This embodiment contains two solid bodies 1, 2 the design of which substantially corresponds to solid body 1 of FIG. 2. The two solid bodies 1, 2 form the two end elements of the resonator. Their second surfaces 12, 22 can be coated with reflecting layers. In order for the known stability condition for the resonator to be fulfilled the resonator parameters such as resonator length and radii R1, R2 of curving of the second surfaces 12, 22 of solid bodies 1, 2 must be matched to each other which, however, is no problem for the person skilled in the art. This embodiment has the advantage compared to the resonator of FIG. 2 that is manages without a focusing element in the resonator activity, whereby at the same time the advantages of the invention are maintained.

In FIG. 4 a solid body 1 or a further embodiment of an resonator according to the invention is shown. This solid body has a first optical surface 11 which is e.g. curved in a convex manner and thus rather acts on the light in the resonator in a focusing manner while the second optical surface 12 is plane. The rest (not shown) of the resonator can correspond to that of FIG. 2 or 3 or also be designed differently.

On the solid body in FIG. 5 the first optical surface 11 as well as the second optical surface 12 are plane, the geometric form of this solid body thus substantially corresponds to that of FIG. 1. In opposition to the state of the art, however, an inhomogeneous refractive index distribution exists and/or can be generated such that the solid body 1 has a focusing effect on the light. The generating of this kind of inhomogeneous refractive index distribution can e.g. be caused by interaction of (not shown) pump light with the solid body 1, which can simultaneously be the amplification medium of a laser. Hereby a kind of thermal lens 14—shown in broken lines in FIG. 5 for didactic reasons—is formed in solid body 1. An inhomogeneous refractive index distribution or an internal lens effect respectively can also be generated by a corresponding doping concentration profile in the solid body 1.

FIG. 6 shows an embodiment of a laser according to the invention diagrammatically. The laser comprises an optical resonator according to the invention. A first end element 31 of the resonator is designed as a mirror with saturable absorbers made of semiconductor materials (semiconductor saturable absorber mirror, SESAM); this kind of SESAM is for the mode coupling for generation of ultrashort laser pulses in the femtosecond or picosecond range (cf. U. Keller et al., “Semiconductor Saturable Absorber Mirrors (SESAMs) for Femtosecond to Nanosecond Pulse Generation in Solid-State Lasers”, IEEE Journal of Selected Topics in Quantum Electronics, Vol. 2, No. 3, September 1996). A second end element 32 is a partially permeable output mirror with a transmission of e.g. 3%. In this embodiment the resonator is multiply folded by means of plane and concave-spherical or concave-cylindrical mirrors 61-64 respectively; exemplified parameters are: R₆₁=400 mm (spherical; R₆₂=203 mm (cylindrical, direction of influence vertical to the plane of the drawing); R₆₃=∞; R₆₄=1500 mm (spherical); a₁=200 mm; a₂+a₃+a₄=405 mm; a₅+a₆+a₇=1150 mm; a₈1280 mm.

The focusing solid body 1 is, with this laser, simultaneously the amplification medium. It is made of e.g. phosphate glass doped with 1% neodymium. The laser further contains a pumping mechanism 7 which contains a pump light source 71 emitting pump light 72, 73, i.e. a linear arrangement of diode lasers. The pump light source 71 is followed by pump optics 74 which separate the pump light 72, 73 and focus it through the first optical surface 11 as well as the second optical surface 12 into the amplifying medium or the solid body 1 respectively. The solid body 1 does not form, as in FIGS. 1-5, an end element of the laser resonator but is arranged on the inside of the resonator activity.

The focusing in solid body 1 works according to the principle shown in FIG. 5. The first optical surface 11 as well as the second optical surface 12 of solid body 1 are designed to be plane. By means of interaction of the pump light 71, 72 with the solid body 1 a thermal effect is created. This lens effect amplifies the negative dispersion created by the Brewster surface 11 of solid body 1 to such a degree that it is sufficient for compensation of the positive dispersion of the resonator. Thus the generation of ultrashort soliton pulses is possible without other techniques for compensation of dispersion. The light 5 in the resonator advantageously hits the first optical surface 11 at Brewster's angle; the second optical surface is mirror-coated. The length of the solid body 1 in its middle is l=7.5 mm. It must be mentioned here that in this exemplified laser the focusing solid body 1 is not an end element of the laser resonator but is located in the resonator cavity and at the same time also takes over the functions of the amplification medium as well as a folding mirror.

Experimental results achieved with the pulse laser according to the invention of FIG. 6 are drawn up in FIGS. 7 and 8 respectively. The curve 91 in FIG. 7 shows the auto-correlation function vs. time t; the curve 93 in FIG. 8 shows the spectrum s sv. wavelength λ. A fit calculation with a Sech²-function gives a pulse-half-value-width (FWHM) of Δt=296 fs or Δλ=4.3 nm; the corresponding fit curves 92 and 93 respectively are also shown in FIGS. 7 or 8 respectively. Without focusing according to the invention by the solid body 1 the generation of ultrashort pulses would be impossible because the resulting dispersion would be strongly positive. Further results from this experiment are: absorbed pump performance=9.1 W, output=1.1 W, time-bandwidth-product=0.33.

With knowledge of the invention the person skilled in the art is capable to combine the exemplified embodiments shown here or to design further embodiments.

1. A method for influencing the dispersion of a group velocity of light in a resonant cavity comprising cavity elements including a solid body, the method comprising a directing step and a recirculating step,
the directing step comprising directing a light beam through the solid body and providing angular dispersion of the light beam wherein light enters the solid body through a first surface, is reflected by a second surface and exits the solid body through the first surface,
the solid body being such that light beam portions entering through the first surface, being reflected by the second surface and exiting through the first surface, are focussed by the solid body,
the cavity elements being positioned with respect to each other such that cavity modes having different wavelengths each have a distinct beam path due to wavelength-dependent refraction at the first surface of the solid body,
further characterized in that the wavelength-dependent refraction at the first surface of the solid body leads to a wavelength-dependent cavity round-trip path length which results in a negative contribution to the group velocity dispersion for a cavity round-trip,
the recirculating step comprising at least partially recirculating said light beam in said cavity.

2. The method according to claim 1, wherein the light beam portions are focused on at least one curved optical surface of the solid body.

3. The method according to claim 2 wherein the light beam portions are focused on at least one nonspherical curved surface of the solid body.

4. The method according to claim 1, wherein the light beam portions are focused on the inside of the solid body.

5. The method according to claim 4, wherein the light beam portions are focused by an inhomogeneous refractive index distribution inside the solid body.

6. The method according to claim 5, wherein an inhomogeneity of the refractive index is caused by an inhomogeneity of the temperature inside of the solid body.

7. The method according to claim 6, wherein the solid body is a laser crystal and the inhomogeneity of the temperature arises from an interaction of pump light with the solid body.

8. An optical resonator with influenceable dispersion comprising a resonant cavity being defined by a set of cavity elements,
the cavity elements being positioned together to form a closed optical path,
the cavity elements including a solid body with a first surface and a second surface, the second surface comprising a reflective coating, the solid body being such that light beam portions entering through the first surface, being reflected by the second surface and exiting through the first surface, are focussed by the solid body, and
the solid body being positioned such that light beam portions circulating in the cavity enter through the first surface, are reflected by the second surface and exit through the first surface,
the cavity elements positioned with respect to each other such that cavity modes having different wavelengths each have a distinct beam path due to wavelength-dependent refraction at the first surface of the solid body,
the wavelength-dependent refraction at the first surface of the solid body leading to a wavelength-dependent cavity round-trip path length, resulting in a negative contribution to the group velocity dispersion for a cavity round-trip.

9. The optical resonator according to claim 8, wherein the solid body comprises at least one curved optical surface.

10. The optical resonator according to claim 8, wherein the material of the solid body is such that it shows an inhomogeneous refractive index distribution or makes possible the generation of an inhomogeneous refractive index distribution in the solid body, or wherein the material of the solid body is such that it shows an inhomogeneous refractive index distribution and makes possible the generation of an additional inhomogeneity of the refractive index distribution.

11. The optical resonator according to claim 8, wherein the at least one solid body forms at least one end element of the resonant cavity.

12. The optical resonator according to claim 8, wherein the at least one solid body is arranged on the inside of the resonant cavity and does not form an end element of the resonant cavity.

13. A laser with an optical resonator containing an amplifying medium, wherein the optical resonator comprises a resonant cavity being defined by a set of cavity elements,
the cavity elements being positioned together to form a closed optical path,
the cavity elements including a solid body with a first surface and a second surface, the second surface comprising a reflective coating, the solid body being such that light beam portions entering through the first surface, being reflected by the second surface and exiting through the first surface, are focussed by the solid body,
and the solid body being positioned such that light beam portions circulating in the cavity enter through the first surface, are reflected by the second surface and exit through the first surface,
the cavity elements positioned with respect to each other such that cavity modes having different wavelengths each have a distinct beam path due to wavelength-dependent refraction at the first surface of the solid body,
the wavelength-dependent refraction at the first surface of the solid body leading to a wavelength-dependent cavity round-trip path length, resulting in a negative contribution to the group velocity dispersion for a cavity round-trip.

14. The laser according to claim 13, wherein the solid body forms the amplifying medium of the laser.
